(19) United States
(12) Patent Application Publication
(10) Pub. No.: US 2022/0101204 A1
(43) Pub. Date: Mar. 31, 2022

(54) MACHINE LEARNING COMPONENT UPDATE REPORTING IN FEDERATED LEARNING

(71) Applicant: QUALCOMM Incorporated, San Diego, CA (US)

(72) Inventors: Hung Dinh LY, San Diego, CA (US); June NAMGOONG, San Diego, CA (US); Taesang YOO, San Diego, CA (US); Hwan Joon KWON, San Diego, CA (US); Krishna Kiran MUKKAVILLI, San Diego, CA (US); Naga BHUSHAN, San Diego, CA (US); Tingfang JI, San Diego, CA (US)

(21) Appl. No.: 17/448,653

(22) Filed: Sep. 23, 2021

Related U.S. Application Data
(60) Provisional application No. 63/198,048, filed on Sep. 25, 2020.

(51) Int. Cl. G06N 20/10; H04W 24/10; G06K 9/62

(52) U.S. Cl. CPC G06N 20/10; G06K 9/6267; H04W 24/10

(57) ABSTRACT

Various aspects of the present disclosure generally relate to wireless communication. In some aspects, a client device may receive a reporting configuration that indicates one or more reporting conditions, wherein the reporting configuration further indicates that, based at least in part on the one or more reporting conditions being satisfied, the client device is to report an update associated with a machine learning component. The client device may transmit the update associated with the machine learning component to the server device based at least in part on whether the one or more reporting conditions are satisfied. Numerous other aspects are provided.

### CROSS-REFERENCE TO RELATED APPLICATION

This Patent Application claims priority to U.S. Provisional Patent Application No. 63/198,048, filed on Sep. 25, 2020, entitled “MACHINE LEARNING COMPONENT UPDATE REPORTING IN FEDERATED LEARNING,” and assigned to the assignee hereof. The disclosure of the prior Application is considered part of and is incorporated by reference into this Patent Application

### INTRODUCTION

Aspects of the present disclosure generally relate to wireless communication and to techniques and apparatuses for machine learning component update reporting in federated learning.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or forward link) refers to the communication link from the BS to the UE, and “uplink” (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

Aspects generally include a method of wireless communication performed by a client device includes receiving a reporting configuration that indicates one or more reporting conditions, wherein the reporting configuration further indicates that, based at least in part on the one or more reporting conditions being satisfied, the client device is to report an update associated with a machine learning component; and transmitting the update associated with the machine learning component to the server device based at least in part on whether the one or more reporting conditions are satisfied.

In some aspects, a method of wireless communication performed by a server device includes transmitting, to a client device, a reporting configuration that indicates one or more reporting conditions, wherein the reporting configuration further indicates that, based at least in part on the one or more reporting conditions being satisfied, the client device is to report an update associated with a machine learning component; and receiving the update associated with the machine learning component from the client device based at least in part on whether the one or more reporting conditions are satisfied.

In some aspects, a client device for wireless communication includes a memory; and one or more processors coupled to the memory, the memory and the one or more processors configured to receive a reporting configuration that indicates one or more reporting conditions, wherein the reporting configuration further indicates that, based at least in part on the one or more reporting conditions being satisfied, the client device is to report an update associated with a machine learning component; and transmit the update associated with the machine learning component to the server device based at least in part on whether the one or more reporting conditions are satisfied.

In some aspects, a server device for wireless communication includes a memory; and one or more processors coupled to the memory, the memory and the one or more processors configured to transmit, to a client device, a reporting configuration that indicates one or more reporting conditions, wherein the reporting configuration further indicates that, based at least in part on the one or more reporting conditions being satisfied, the client device is to report an update associated with a machine learning component; and receive the update associated with the machine learning component from the client device based at least in part on whether the one or more reporting conditions are satisfied.

In some aspects, a non-transitory computer-readable medium storing a set of instructions for wireless communication includes one or more instructions that, when executed by one or more processors of a client device, cause the client device to receive a reporting configuration that indicates one or more reporting conditions, wherein the reporting configuration further indicates that, based at least in part on the one or more reporting conditions being satisfied, the client device is to report an update associated with a machine learning component; and transmit the update associated with the machine learning component to the server device based at least in part on whether the one or more reporting conditions are satisfied.

In some aspects, a non-transitory computer-readable medium storing a set of instructions for wireless communication includes one or more instructions that, when executed by one or more processors of a server device, cause the server device to transmit, to a client device, a reporting configuration that indicates one or more reporting conditions, wherein the reporting configuration further indicates that, based at least in part on the one or more reporting conditions being satisfied, the client device is to report an update associated with a machine learning component; and receive the update associated with the machine learning component from the client device based at least in part on whether the one or more reporting conditions are satisfied.

In some aspects, an apparatus for wireless communication includes means for receiving a reporting configuration that indicates one or more reporting conditions, wherein the reporting configuration further indicates that, based at least in part on the one or more reporting conditions being satisfied, the apparatus is to report an update associated with a machine learning component; and means for transmitting the update associated with the machine learning component to the server device based at least in part on whether the one or more reporting conditions are satisfied.

In some aspects, an apparatus for wireless communication includes means for transmitting, to a client device, a reporting configuration that indicates one or more reporting conditions, wherein the reporting configuration further indicates that, based at least in part on the one or more reporting conditions being satisfied, the client device is to report an update associated with a machine learning component; and means for receiving the update associated with the machine learning component from the client device based at least in part on whether the one or more reporting conditions are satisfied.

In some aspects, a method, device, apparatus, system, computer program product, non-transitory computer-readable medium, user equipment, base station, node, wireless communication device, client device, server device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3 and 4 are diagrams illustrating examples associated with machine learning component update reporting in federated learning, in accordance with the present disclosure.

FIGS. 5 and 6 are diagrams illustrating example processes associated with machine learning component update reporting in federated learning, in accordance with the present disclosure.

FIGS. 7-10 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

Various aspects may include one or more client devices that may communicate with one or more server devices. Client devices may include software and/or hardware configured to perform one or more operations and to communicate with one or more server devices. Server devices may include software and/or hardware configured to perform one or more operations and to communicate with one or more client devices. Client devices and/or server devices may be, include, be included in, and/or be implemented on any number of different types of computing devices such as, for example, network devices (e.g., wireless network devices and/or wired network devices), portable computers, laptops, tablets, workstations, personal computers, controllers, in-vehicle control networks, Internet-of-Things (IoT) devices, traffic control devices, integrated access and backhaul (IAB) nodes, user equipment (UEs), base stations, relay stations, switches, routers, customer premises equipment (CPEs), and/or vehicles (e.g., land-based vehicles, aerial vehicles, non-terrestrial vehicles, and/or water-based vehicles).

As indicated above, in some aspects, client devices and/or server devices may be, include, be included within, and/or be implemented on one or more wireless network devices. For example, in some aspects, a client device may be, include, be included in, and/or be implemented on a UE and a server device may be, include, be included in, and/or be implemented on a base station. In some aspects, a client device may include a server device that is configured to operate as a client. In some aspects, a server device may include a client device configured to operate as a server. In some aspects, one or more server devices and/or one or more client devices may communicate using any number of types of communication connections such as, for example, wired networks, wireless networks, multi-hop networks, and/or combinations of wired networks, wireless networks, and/or multi-hop networks.

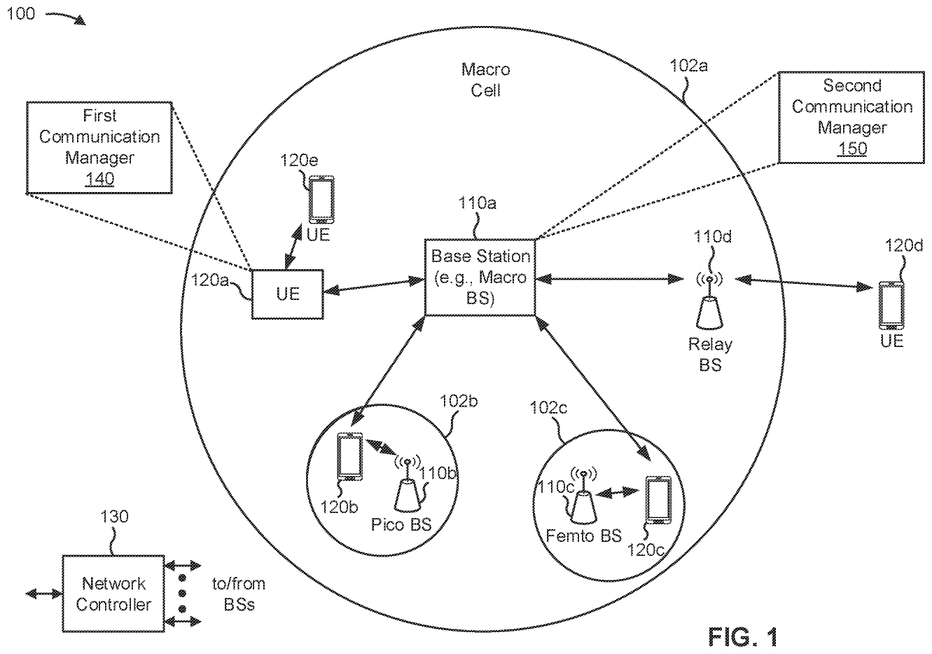

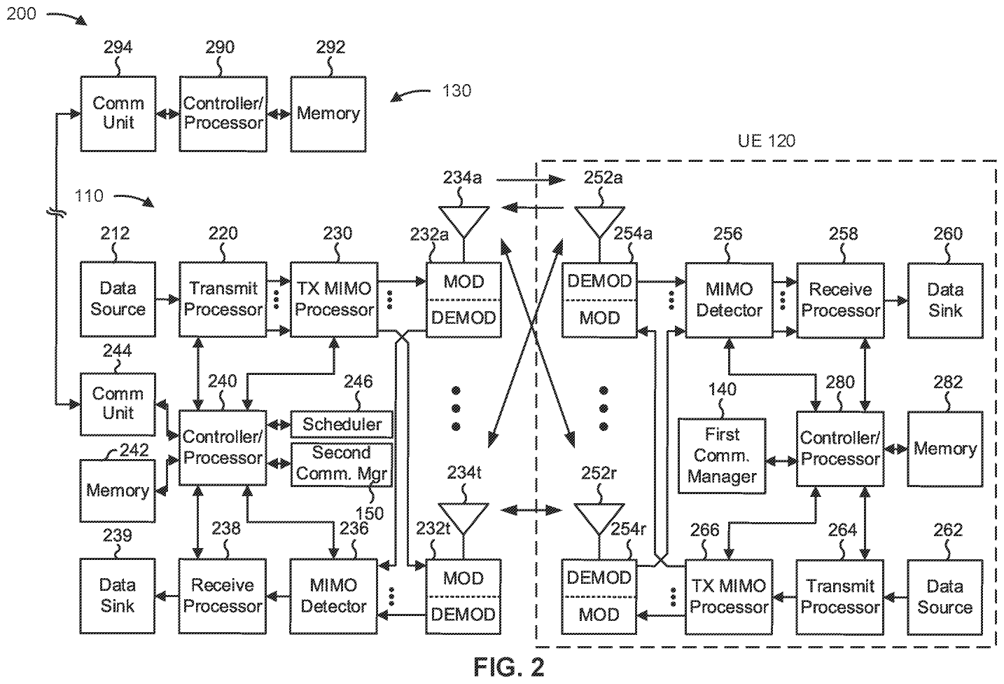

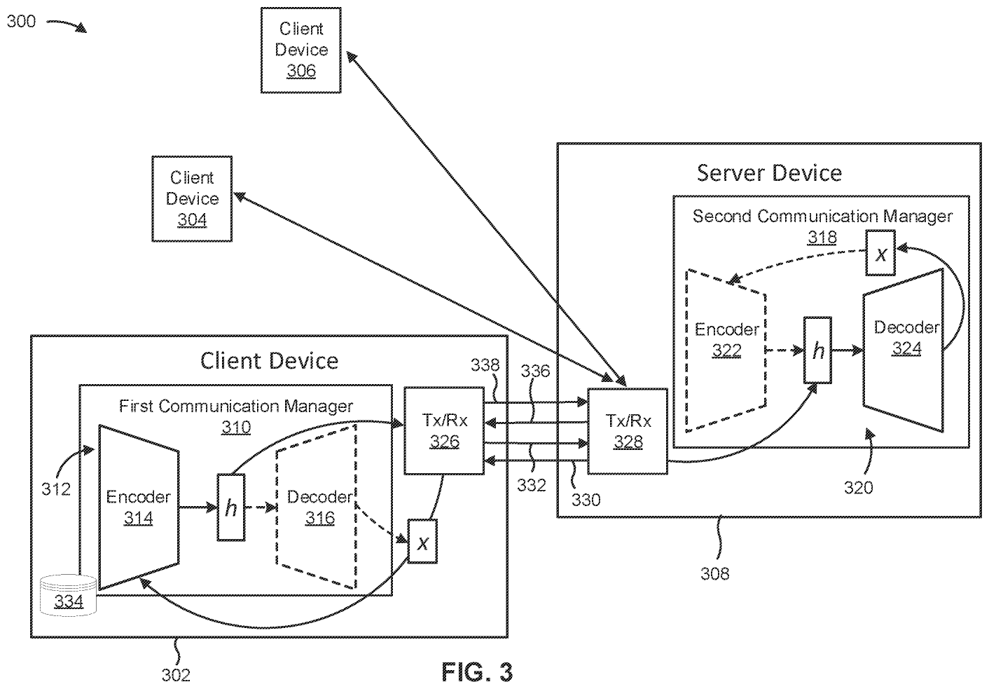

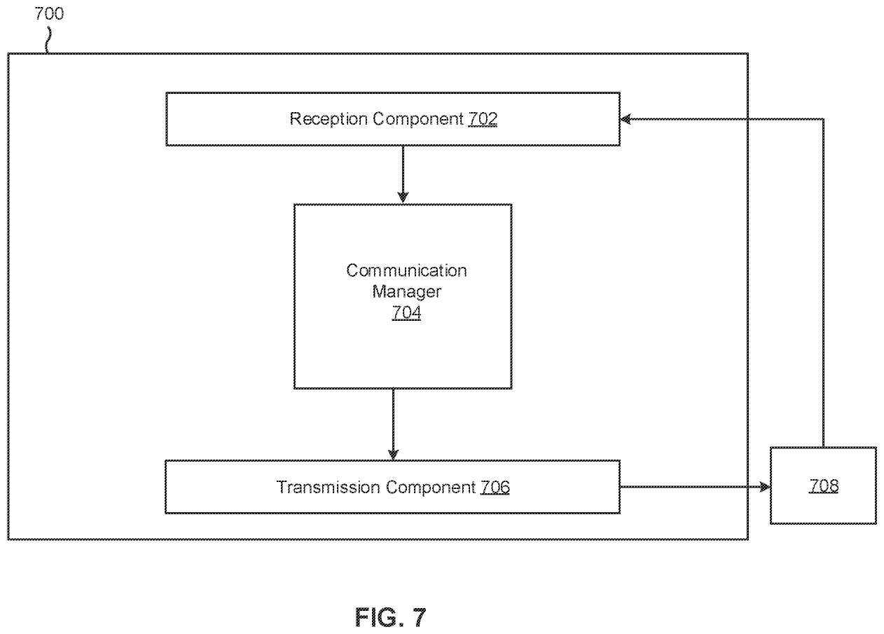

FIGS. 1 and 2, and the accompanying text below, provide examples of aspects of wireless networks and wireless network devices that may be used to implement one or more aspects of subject matter disclosed herein. FIGS. 3-6, and the accompanying text, describe aspects of operations that may be performed by client devices and/or server devices, which may include, for example, UEs and base stations as shown in, and described in connection with, FIGS. 1 and 2, and/or other implementations of client devices and/or server devices such as, for example, those described above. FIGS. 7-10, and the accompanying text, describe examples of apparatuses for implementing client devices and/or server devices, in accordance with various aspects of the present disclosure. The apparatuses may include wireless network devices and/or any number of other computing devices, as indicated above in connection with client devices and/or server devices.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

FIG. 1 is a diagram illustrating an example of a wireless network 100, in accordance with the present disclosure. As indicated above, one or more aspects of the wireless network 100 may be used to implement aspects of one or more clients and servers as shown in FIG. 3 and described below in connection therewith. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used. In some aspects, a base station 110 may be, include, be included in, and/or be used to implement a server such as the server device 308 shown in FIG. 3 and described below. A UE may be, include, be included in, and/or be used to implement a client such as the client device 302 shown in FIG. 3 and described below. In some aspects, a base station 110 may be may be, include, be included in, and/or be used to implement a client. In some aspects, a UE 120 may be, include, be included in, and/or be used to implement a server.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

In some aspects, the wireless network 100 may include one or more non-terrestrial network (NTN) deployments in which a non-terrestrial wireless communication device may include a UE (referred to herein, interchangeably, as a “non-terrestrial UE”), a BS (referred to herein, interchangeably, as a “non-terrestrial BS” and “non-terrestrial base station”), a relay station (referred to herein, interchangeably, as a “non-terrestrial relay station”), and/or the like. As used herein, “NTN” may refer to a network for which access is facilitated by a non-terrestrial UE, non-terrestrial BS, a non-terrestrial relay station, and/or the like.

The wireless network 100 may include any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, a high elliptical orbit (HEO) satellite, and/or the like. A manned aircraft system may include an airplane, helicopter, a dirigible, and/or the like. A UAS platform may include a high-altitude platform station (HAPS), and may include a balloon, a dirigible, an airplane, and/or the like. A non-terrestrial wireless communication device may be part of an NTN that is separate from the wireless network 100. Alternatively, an NTN may be part of the wireless network 100. Satellites may communicate directly and/or indirectly with other entities in wireless network 100 using satellite communication. The other entities may include UEs (e.g., terrestrial UEs and/or non-terrestrial UEs), other satellites in the one or more NTN deployments, other types of BSs (e.g., stationary and/or ground-based BSs), relay stations, one or more components and/or devices included in a core network of wireless network 100, and/or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul. For example, in some aspects, the wireless network 100 may be, include, or be included in a wireless backhaul network, sometimes referred to as an integrated access and backhaul (IAB) network. In an IAB network, at least one base station (e.g., base station 110) may be an anchor base station that communicates with a core network via a wired backhaul link, such as a fiber connection. An anchor base station may also be referred to as an IAB donor (or IAB-donor), a central entity, a central unit, and/or the like. An IAB network may include one or more non-anchor base stations, sometimes referred to as relay base stations, IAB nodes (or IAB-nodes). The non-anchor base station may communicate directly with or indirectly with (e.g., via one or more non-anchor base stations) the anchor base station via one or more backhaul links to form a backhaul path to the core network for carrying backhaul traffic. Backhaul links may be wireless links. Anchor base station(s) and/or non-anchor base station(s) may communicate with one or more UEs (e.g., UE 120) via access links, which may be wireless links for carrying access traffic.

In some aspects, a radio access network that includes an IAB network may utilize millimeter wave technology and/or directional communications (e.g., beamforming, precoding and/or the like) for communications between base stations and/or UEs (e.g., between two base stations, between two UEs, and/or between a base station and a UE). For example, wireless backhaul links between base stations may use millimeter waves to carry information and/or may be directed toward a target base station using beamforming, precoding, and/or the like. Similarly, wireless access links between a UE and a base station may use millimeter waves and/or may be directed toward a target wireless node (e.g., a UE and/or a base station). In this way, inter-link interference may be reduced.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In some aspects, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As shown in FIG. 1, the UE 120 may include a first communication manager 140. As described in more detail elsewhere herein, the first communication manager 140 may receive a reporting configuration that indicates one or more reporting conditions, wherein the reporting configuration that indicates one or more reporting conditions, wherein the reporting configuration further indicates that, based at least in part on the one or more reporting conditions being satisfied, the client device is to report an update associated with a machine learning component; and transmit the update associated with the machine learning component to the server device based at least in part on whether the one or more reporting conditions are satisfied. Additionally, or alternatively, the first communication manager 140 may perform one or more other operations described herein.

In some aspects, the base station 110 may include a second communication manager 150. As described in more detail elsewhere herein, the second communication manager 150 may transmit, to a client device, a reporting configuration that indicates one or more reporting conditions, wherein the reporting configuration further indicates that, based at least in part on the one or more reporting conditions being satisfied, the client device is to report an update associated with a machine learning component; and receive the update associated with the machine learning component from the client device based at least in part on whether the one or more reporting conditions are satisfied. Additionally, or alternatively, the second communication manager 150 may perform one or more other operations described herein.

As indicated above, FIG. 1 is provided merely as an example. Other examples may differ from what is described with regard to FIG. 1.

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports comprising RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

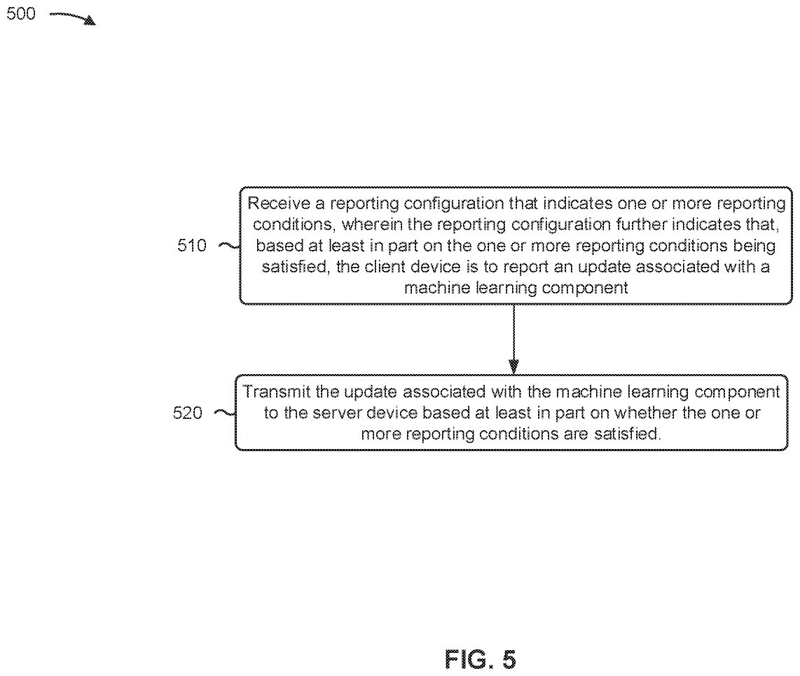

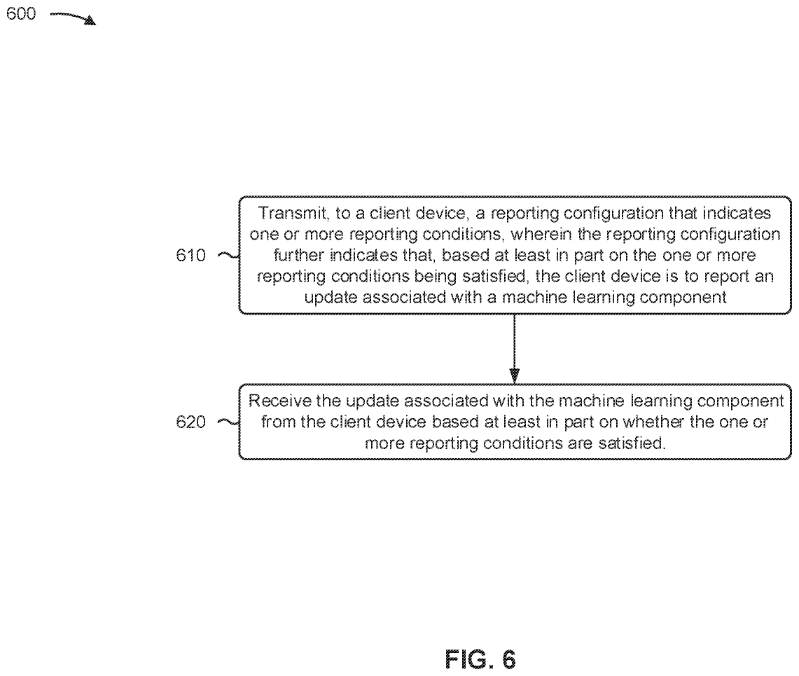

Controller/processor 240 of base station 110, controller/processor 280 of UE 120, and/or any other component(s) of FIG. 2 may perform one or more techniques associated with machine learning component update reporting in federated learning, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some aspects, executing instructions may include running the instructions, converting the instructions, compiling the instructions, and/or interpreting the instructions, among other examples.

In some aspects, a client (e.g., the UE 120) may include means for receiving a reporting configuration that indicates one or more reporting conditions, wherein the reporting configuration further indicates that, based at least in part on the one or more reporting conditions being satisfied, the client device is to report an update associated with a machine learning component and/or means for transmitting the update associated with the machine learning component to the server device based at least in part on whether the one or more reporting conditions are satisfied, among other examples. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, and/or receive processor 258, among other examples.

In some aspects, a server (e.g., the base station 110) may include means for transmitting, to a client device, a reporting configuration that indicates one or more reporting conditions, wherein the reporting configuration further indicates that, based at least in part on the one or more reporting conditions being satisfied, the client device is to report an update associated with a machine learning component and/or means for receiving the update associated with the machine learning component from the client device based at least in part on whether the one or more reporting conditions are satisfied, among other examples. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, and/or antenna 234, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

A client device operating in a network may report information to a server device. The information may include information associated with received signals and/or positioning information, among other examples. For example, a client device may perform measurements associated with reference signals and report the measurements to a server device. In some examples, the client device may measure reference signals during a beam management process for channel state feedback (CSF), may measure received power of reference signals from a serving cell and/or neighbor cells, may measure signal strength of inter-radio access technology (e.g., WiFi) networks, and/or may measure sensor signals for detecting locations of one or more objects within an environment. However, reporting information to the server device may consume communication and/or network resources.

To mitigate consumption of resources, a client device (e.g., a UE, a base station, a transmit receive point (TRP), a network device, a low-earth orbit (LEO) satellite, a medium-earth orbit (MEO) satellite, a geostationary earth orbit (GEO) satellite, and/or a high elliptical orbit (HEO) satellite) may use one or more machine learning components (e.g., neural networks) that may be trained to learn dependence of measured qualities on individual parameters, isolate the measured qualities through various layers of the one or more machine learning components (also referred to as “operations”), and compress measurements in a way that limits compression loss. The client device may transmit the compressed measurements to the server device (e.g., a TRP, another UE, and/or a base station). The server device may decode the compressed measurements using one or more decompression operations and reconstruction operations associated with one or more machine learning components. The one or more decompression and reconstruction operations may be based at least in part on a set of features of the compressed data set to produce reconstructed measurements. The server device may perform a wireless communication action based at least in part on the reconstructed measurements.

A machine learning component is a component (e.g., hardware, software, or a combination thereof) of a client device that performs one or more machine learning procedures. A machine learning component may include, for example, hardware and/or software that may learn to perform a procedure without being explicitly trained to perform the procedure. A machine learning component may include, for example, a feature learning processing block and/or a representation learning processing block. A machine learning component may include one or more neural networks. A neural network may include, for example, an autoencoder.

In some aspects, a machine learning component may be configured to determine a latent vector based at least in part on an observed wireless communication vector. In some aspects, the observed wireless communication vector and the latent vector may be associated with a wireless communication task. The observed wireless communication vector may include an array of observed values associated with one or more measurements obtained in connection with a wireless communication. In some aspects, for example, the wireless communication task may include determining channel state feedback (CSF), determining positioning information associated with the client device, determining a modulation associated with a wireless communication, and/or determining a waveform associated with a wireless communication. The latent vector h is the output of a machine learning component that takes the observed wireless communication vector as input. The latent vector may include an array of hidden values associated with one or more aspects of the observed communication vector.

In some cases, machine learning components may be trained using federated learning. Federated learning is a machine learning technique that enables multiple clients to collaboratively learn machine learning models based on training data, while the server device does not collect the training data from the client devices. Federated learning techniques may involve one or more global neural network models trained from data stored on multiple client devices. For example, in a Federated Averaging algorithm, the server device sends the neural network model to the client devices. Each client device trains the received neural network model using its own data and sends back an updated neural network model to the server device. The server device averages the updated neural network models from the client devices to obtain a new neural network model.

However, in some cases, some client devices may be operating in different scenarios than other client devices (e.g. indoor/outdoor, stationary in a coffee shop/mobile on a highway, and/or the like). In some cases, different client devices may be subject to different implementation aspects (e.g. different form factors, different RF impairments, and/or the like). As a result, in some examples, finding a machine learning component model that works well on all the devices in a federated learning network in terms of physical layer link performance may be difficult.

To provide and train personalized machine learning components adapted for respective client devices, a machine learning component may be customized based on an environment of a client device. In some cases, an observed environmental vector may be used to characterize an environment of a client device. An observed environmental vector may include an array of observed values associated with one or more features of an environment of a client device. An environment of a client device may include any characteristic associated with the client device that may affect an operation of the client device, a signal received by the client device, and/or a signal transmitted by the client device. An operation of the client device may include any operation that may be performed on, or in connection with, any type of information. An operation of the client device may include, for example, receiving a signal, decoding a signal, demodulating a signal, processing a signal, encoding a signal, modulating a signal, and/or transmitting a signal. In some aspects, the one or more features of the environment of the client device may include characteristics of the client device, large scale channel characteristics, channel information, signal information, and/or image data, among other examples.

In some cases, for example, a number of machine learning components may be used by a client. One or more machine learning components may be configured to extract features about an environment of the client to determine a customization feature vector, a conditioning vector, and/or the like. The customization feature vector may be used to condition one or more additional machine learning components to work in the perceived environment. The customization feature vector and an observed wireless communication vector may be provided as input to the one or more additional machine learning components, which may be configured to perform a wireless communication task such as, for example, by providing a latent vector. A conditioning vector may include client-specific parameters that can be loaded into one or more other machine learning components to condition one or more additional machine learning components to work in the perceived environment.

In some cases, a client device may provide the observed environmental vector, the customization feature vector, the conditioning vector, and/or the like to the server device. The client device also may provide the latent vector to the server device, which may use one or more machine learning components corresponding to one or more machine learning components of the client device to recover the observed wireless communication vector.

In some cases, a client device may receive a machine learning component from a server device. The machine learning component may include, for example, a neural network model, parameters corresponding to a neural network model, a set of machine learning models, and/or the like. The client device may train the machine learning component based at least in part on training data that the client device obtains. For example, the client device may obtain the training data based on observations of an environment of the client device and/or processing received signals.

However, the nature and/or extent of data collected by the client device may be impacted by any number of characteristics of the client device. For example, the complexity of the client device may impact the amount of data that the client device can collect (e.g., due to limited memory for storing data, limited processing power for extracting and/or analyzing data, limited power available). In some cases, the client device may be configured to perform tasks (e.g., communication, mobility management, beam management) that have a higher priority than collecting data, updating machine learning components, and/or the like.

In some cases, a client device may collect a large amount of data, but the data may not be useful for training a machine learning component. In some cases, collected data may be used for training a machine learning component, but the performance of the machine learning component may not be improved by training using the data. In some cases, the machine learning component may be improved, but may not be improved by an amount significant enough to warrant providing an update to a server device. For example, training data collected when a client device is stationary may not be useful for training a machine learning component with respect to a moving environment. Thus, providing regular updates of the machine learning component to the server device may be inefficient and consume network processing and/or communication resources for little overall benefit, thereby negatively impacting network performance.

Aspects of the techniques and apparatuses described herein may facilitate machine learning component update reporting in federated learning. In some aspects, a client device may receive a reporting configuration that indicates a reporting condition. The reporting configuration may include an indication to report an update associated with a machine learning component based at least in part on the reporting condition. In this way, reporting of updates may be limited to situations in which the update may facilitate a useful update to a machine learning component maintained at the server device. As a result, aspects may lead to more efficient use of network resources in federated learning, thereby positively impacting network performance. Aspects of the techniques described herein may be used for any number of cross-node machine learning challenges including, for example, facilitating channel state feedback, facilitating positioning of a client device, and/or learning of modulation and/or waveforms for wireless communication.

FIG. 3 is a diagram illustrating an example 300 of machine learning component update reporting in federated learning, in accordance with the present disclosure. As shown, a number of client devices 302, 304, and 306 may communicate with a server device 308. The client devices 302, 304, and 306 and the server device 308 may communicate with one another via a wireless network (e.g., the wireless network 100 shown in FIG. 1). In some cases, more than one client device 302, 304, 306 and/or more than one server device 308 may communicate with one another.

The client device 302, 304, and/or 306 and/or the server device 308 may be, be similar to, include, be included in, and/or be implemented using a computing device. The computing device may include, for example, a wireless communication device a network device (e.g., a wireless network device and/or wired network device), a portable computer, a laptop, a tablet, a workstation, a personal computer, a controller, an in-vehicle control network, an IoT device, a traffic control device, an IAB node, a UE, a base station, a relay station, a switch, a router, a CPE, a vehicle (e.g., land-based vehicles, aerial vehicles, non-terrestrial vehicles, and/or water-based vehicles), and/or any combination and/or For example, the client device 302 may be a UE (e.g., UE 120 shown in FIG. 1) and the server device 308 may be a base station (e.g., base station 110 shown in FIG. 1), and the client device 302 and the server device 308 may communicate via an access link. The client device 302 and the server device 308 may be UEs 120 that communicate via a sidelink.

FIG. 3 illustrates the client device 302. The client devices 304 and/or 306 may be similar to the client device 302 and/or may have the same or similar aspects as the client device 302. As shown, the client device 302 may include a first communication manager 310 (e.g., the first communication manager 140 shown in FIG. 1) that may be configured to utilize a machine learning component (shown, for example, as a first client autoencoder) 312 to perform one or more wireless communication tasks. The first communication manager 310 may be configured to utilize any number of additional machine learning components not shown in FIG. 3.

As shown, the machine learning component 312 may include an encoder 314 configured to receive an observed wireless communication vector, x, and to provide a latent vector, h, as output. The machine learning component 312 also may include a decoder 316 configured to receive the latent vector, h, and to provide the observed wireless communication vector x as output. As shown in FIG. 3, the server device 308 may include a second communication manager 318 (e.g., the second communication manager 150) that may be configured to utilize a server machine learning component (shown, for example, as a server autoencoder) 320 to perform one or more wireless communication tasks. For example, in some aspects, the server machine learning component 320 may correspond to the client machine learning component 312. The second communication manager 318 may be configured to utilize any number of additional machine learning components not shown in FIG. 3. The server machine learning component 320 may include an encoder 322 configured to receive the observed wireless communication vector x as input and to provide a latent vector h as output. The server machine learning component 320 also may include a decoder 324 configured to receive the latent vector h as input and to provide the observed wireless communication vector x as output.

As shown in FIG. 3, the client device 302 may include a transceiver (shown as “Tx/Rx”) 326 that may facilitate wireless communications with a transceiver 328 of the server device 308. As shown by reference number 330, the server device 308 may transmit, using the transceiver 328, a wireless communication to the client device 302. The wireless communication may include, for example, a reference signal such as a channel state information reference signal (CSI-RS). The transceiver 326 of the client device 302 may receive the wireless communication. The communication manager 310 may determine an observed wireless communication vector x based at least in part on the wireless communication. For example, in aspects in which the wireless communication is a CSI-RS, the observed wireless communication vector x may include channel state information (CSI).

As shown, the communication manager 310 may provide, as input, the observed wireless communication vector x, to the encoder 314 of the client machine learning component 312. In some aspects, the communication manager 310 also may provide, as input to the encoder 314, a feature vector associated with an environment of the client device 302. In some aspects, the communication manager 310 may also load client-specific parameters into one or more levels of the encoder 314. The encoder 314 of the client machine learning component 312 may determine, based at least in part on the observed wireless communication vector x, a latent vector h. As shown, the communication manager 310 may provide the latent vector h to the transceiver 326 for transmission. As shown by reference number 332, the transceiver 326 may transmit, and the transceiver 328 of the server device 308 may receive, the latent vector h. As shown, the communication manager 318 of the server device 308 may provide the latent vector h as input to the decoder 324 of the server machine learning component 320. The decoder 324 may determine (e.g., reconstruct) the observed wireless communication vector x based at least in part on the latent vector h. In some aspects, the server device 308 may perform a wireless communication action based at least in part on the observed wireless communication vector x. For example, in aspects in which the observed wireless communication vector x comprises CSI, the communication manager 318 of the server device 308 may use the CSI for communication grouping, beamforming, and/or the like.

The client devices 302, 304, and 306 may locally train machine learning components using training data collected by the client device 302, 304, and 306, respectively. A client device 302, 304, or 306 may train a machine learning component such as a neural network by optimizing a set of model parameters, w⁽ⁿ⁾, associated with the machine learning component, where n is the federated learning round index. The set of client devices 302, 304, and 306 may be configured to provide updates to the server device 308 multiple times (e.g., periodically, on demand, upon updating a local machine learning component, etc.). Each time the server device 308 receives updates from a client device 302, 304, 306, it is referred to as a round. The federated learning round index indicates the number of the round since the last global update was transmitted, by the server device 308, to the client device 302, 304, 306.

In some aspects, for example, the first communication manager 310 of the client device 302 may determine an update corresponding to the machine learning component 312 by training the machine learning component 312. In some aspects, the client device 302 may collect training data and store it in a memory device 334. The stored training data may be referred to as a “local dataset.” In some aspects, the first communication manager 310 may access training data from the memory device 334 and use the training data to generate training output from the machine learning component 312.

For example, as indicated by the dashed lines associated with the first machine learning component 312, the decoder 316 may be used, along with training data, to reconstruct a wireless communication training vector. The reconstructed training vector may be used to facilitate determining the model parameters w⁽ⁿ⁾ that maximize a variational lower bound function. The negative variational lower bound function may correspond to a global loss function, F(w), associated with the machine learning component. A stochastic gradient descent (SGD) algorithm may be used to optimize the model parameters w⁽ⁿ⁾. The client device 302 may perform one or more SGD procedures to determine the optimized parameters w⁽ⁿ⁾ and may determine gradients, gₖ⁽ⁿ⁾, of the loss function with respect to the loss function F(w), where k is an index identifying the client device. The first communication manager 310 may further refine the machine learning component 312 based at least in part on the loss function value, the gradients, and/or the like.

By training the machine learning component, the first communication manager 310 may determine an update corresponding to the machine learning component 312. In some aspects, the update may include an updated set of model parameters w⁽ⁿ⁾, a difference between the updated set of model parameters w⁽ⁿ⁾ and a prior set of model parameters w⁽ⁿ⁻¹⁾, the gradients gₖ⁽ⁿ⁾, an updated machine learning component model, and/or the like. The client device 302 may transmit the update, or a compressed version thereof, to the server device 308, as described below.

As shown by reference number 336, the server device 308 may transmit, and the client device 302 may receive, a reporting configuration. According to various aspects, the reporting configuration may be carried in a downlink control information transmission, a radio resource control message, a medium access control (MAC) control element (CE), a random access channel (RACH) procedure, and/or the like. In some aspects, the reporting configuration may indicate whether the client device 302 is to update a machine learning component and/or provide the update to the server device 308.

In some aspects, the reporting configuration may indicate one or more reporting conditions and may include an indication to report an update associated with the machine learning component based at least in part on the one or more reporting conditions. The one or more reporting conditions may correspond to an amount of training data collected by the client device 302. The one or more reporting conditions may include a data quantity threshold. For example, in some aspects, the client device 302 may determine an amount of training data collected by the client device 302 during a collection period (e.g., some specified period of time) and determine whether the amount (e.g., in samples, gigabytes, etc.) of training data collected by the client device 302 satisfies the data quantity threshold.

As shown by reference number 338, if the amount of training data collected satisfies the data quantity threshold the client device 302 may transmit the update to the server device 308. According to various aspects, the server device 308 may receive updates to machine learning components from the client device 304 and/or the client device 306, as well. The second communication manager 318 may average the updates received and use the average updates to update the server machine learning component 320.

In some aspects, the client device 302 may transmit the update based at least in part on determining that the amount of training data collected by the client device satisfies the data quantity threshold. In some aspect, the client device 302 may determine an update corresponding to a machine learning component based at least in part on determining that the amount of training data collected by the client device satisfies the data quantity threshold.

In some aspects, the one or more reporting conditions may correspond to a performance of the machine learning component. In some aspects, for example, the one or more reporting conditions may correspond to a combination of a data quantity threshold and a performance measure associated with the machine learning component. The “performance” of a machine learning component may refer to an accuracy with which the machine learning component performs the task for which it was designed. A loss function value, for example, may be used to determine a performance of the machine learning component. For example, in some aspects, the one or more reporting conditions may include a loss function threshold. The client device may transmit an update to a machine learning component if a loss function value corresponding to the update satisfies the loss function threshold.

In some aspects, the one or more reporting conditions may correspond to a loss function difference. The loss function difference may include a difference between a first loss function value associated with the machine learning component and a second loss function value associated with the machine learning component. The first loss function value may correspond to an initial instance of the machine learning component, and the second loss function value may correspond to an updated instance of the machine learning component. The initial instance of the machine learning component may be the instance at which the machine learning component is provided to the client device 302, a most recent (or otherwise prior) instance of the machine learning component, and/or the like.

In some aspects, for example, the client device 302 may receive initial machine learning component information. The initial machine leaning component information may include an initial machine learning component, an initial set of parameters associated with a machine learning component, and/or the like. In some aspects, the client device 302 may determine the first loss function value, determine the second loss function value, and determine the loss function difference. The client device 302 may further determine whether the that the loss function difference satisfies the reporting condition. In some aspects, the client device 302 may transmit the update based at least in part on determining that the loss function difference satisfies a loss function threshold.

In some aspects, the one or more reporting conditions correspond to a use case associated with the machine learning component. The use case may include at least one of a CSI derivation, a positioning measurement derivation, demodulation of a data channel, decoding of a data channel, or a combination thereof. The one or more reporting conditions may correspond to a data type associated with a set of collected data. The data type may include identical independent distributed (I.I.D.) data. In some aspects, transmitting the update is based at least in part on a determination that the set of collected data comprises I.I.D. data. The one or more reporting conditions may indicate at least one communication resource to be used for reporting the update. The at least one communication resource comprises at least one of a time resource or a frequency resource.

In some aspects, a client device 302 and/or a server device 308 may perform one or more additional operations. A client device 302 and/or a server device 308 may be configured, for example, to use one or more different types of machine learning components, to use one or more procedures and/or components in addition to, or in lieu of one or more machine learning components. For example, in some aspects, a client device 302 and/or a server device 308 may be configured to perform a first type of procedure in connection with a received signal and to perform a second type of procedure in connection with the received signal and/or another received signal. The first type of procedure may be performed using a first algorithm, a first processing block, and/or a first machine learning component, and the second type of procedure may be performed using a second algorithm, a second processing block, and/or a second machine learning component. In an example, a client device 302 may determine a first CSI associated with a received signal using a first procedure and may determine a second CSI associated with the received signal and/or a different received signal using a second procedure.

As indicated above, FIG. 3 is provided merely as an example. Other examples may differ from what is described with regard to FIG. 3.

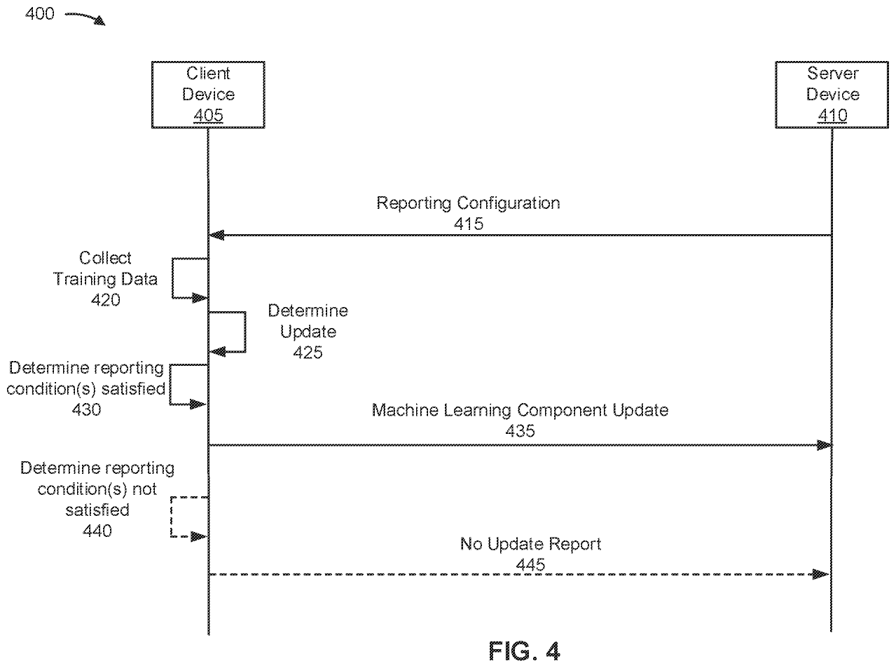

FIG. 4 is a diagram illustrating an example 400 of machine learning component update reporting in federated learning, in accordance with the present disclosure. As shown, a client device 405 and a server device 410 may communicate with one another. In some aspects, the client device 405 may be, be similar to, include, or be included in the client device 302 shown in FIG. 3. In some aspects, the server device 410 may be, be similar to, include, or be included in the server device 308 shown in FIG. 3.

As shown by reference number 415, the server device 410 may transmit, and the client device 405 may receive, a reporting configuration. The reporting configuration may indicate one or more reporting conditions. The reporting configuration may include an indication to report, to the server device 410, an update associated with a machine learning component based at least in part on the one or more reporting conditions. In some aspects, the reporting configuration may indicate at least one communication resource to be used for reporting an update. For example, the reporting configuration may indicate a time resource, a frequency resource, and/or a spatial resource.

The one or more reporting conditions may correspond to an amount of training data collected by the client device 405. For example, the one or more reporting conditions may include a data quantity threshold. The one or more reporting conditions may correspond to a performance of the machine learning component. The one or more reporting conditions may correspond to a loss function value of the machine learning component. For example, the one or more reporting conditions may include a loss function value threshold. The one or more reporting conditions may correspond to a loss function difference, which may be a difference between a first loss function value associated with the machine learning component and a second loss function value associated with the machine learning component.

The one or more reporting conditions may correspond to a use case associated with the machine learning component. The use case may include at least one of a CSI derivation, a positioning measurement derivation, demodulation of a data channel, decoding of a data channel, or a combination thereof. The one or more reporting conditions may correspond to a data type associated with a set of collected data. The data type may include I.I.D. data, for example. In some aspects, the one or more reporting conditions may include a combination of any of the above and/or reporting conditions not explicitly indicated herein.

As shown by reference number 420, the client device 405 may collect training data. In some aspects, the reporting configuration may include an indication to determine an update to the machine learning component based at least in part on determining that the amount of training data collected satisfies a data quantity threshold. As shown by reference number 425, the client device 405 may determine the update. The client device 405 may determine the update, for example, based at least in part on determining that the amount of training data collected satisfies a data quantity threshold.

As shown by reference number 430, the client device 405 may determine that one or more reporting conditions are satisfied. As shown by reference number 435, the client device 405 may transmit, and the server device 410 may receive, a machine learning component update. In some aspects, the client device 405 may transmit the machine learning component update based at least in part on determining that the one or more reporting conditions are satisfied.

As shown by reference number 440, the client device 405 may determine that an additional update associated with the machine learning component fails to satisfy the one or more reporting conditions. The client device 405 may refrain from transmitting an additional update to the server device 410 based at least in part on determining that the additional update fails to satisfy the one or more reporting conditions.

In some aspects, as shown by reference number 445, the client device 405 may transmit, to the server device 410, an indication that the client device is refraining from transmitting an additional update (shown as a “no update report”). In some aspects, the client device 405 the indication that the client is refraining from transmitting an additional update may be transmitted in a report. For example, in some aspects, two different report types may be utilized: a first type that is used for transmitting updates to the machine learning component, and a second type that is used for transmitting an indication that the client device 405 is refraining from transmitting an update. In some aspects, the client device 405 may transmit, in a report, at least one of a loss function value associated with a set of training data or a loss function value associated with a set of validation data.

In some aspects, the server device 410 may configure (e.g., using the reporting configuration) time, frequency, and/or spatial resources for transmitting the two types of reports. Based on the resources used by the client device 405 to transmit a report, the server device 410 may identify the type of report. In some aspects, the server device 410 may perform a blind detection procedure to identify whether the client device 405 has transmitted a report.

In some aspects, the report of the second type may indicate a reporting delay. The reporting delay may include at least one time resource or frequency resource during which the client device 405 will refrain from reporting an update. In some aspects, the report of the second type may indicate a current instance of the machine learning component. In this way, the server device 410 can know that the current instance of the machine learning component is relevant for processing signals.

As indicated above, FIG. 4 is provided merely as an example. Other examples may differ from what is described with regard to FIG. 4.

FIG. 5 is a diagram illustrating an example process 500 performed, for example, by a client device, in accordance with the present disclosure. Example process 500 is an example where the client device (e.g., client device 302 shown in FIG. 3, client device 405 shown in FIG. 4) performs operations associated with machine learning component update reporting in federated learning.

As shown in FIG. 5, in some aspects, process 500 may include receiving a reporting configuration that indicates one or more reporting conditions, wherein the reporting configuration further indicates that, based at least in part on the one or more reporting conditions being satisfied, the client device is to report an update associated with a machine learning component (block 510). For example, the client device e.g., using reception component 702, depicted in FIG. 7) may receive a reporting configuration that indicates one or more reporting conditions, wherein the reporting configuration further indicates that, based at least in part on the one or more reporting conditions being satisfied, the client device is to report an update associated with a machine learning component, as described above.

As further shown in FIG. 5, in some aspects, process 500 may include transmitting the update associated with the machine learning component to the server device based at least in part on whether the one or more reporting conditions are satisfied (block 520). For example, the client device (e.g., using transmission component 706, depicted in FIG. 7) may transmit the update associated with the machine learning component to the server device based at least in part on whether the one or more reporting conditions are satisfied. For example, the process 500 may include transmitting the update based at least in part on a determination that the one or more reporting conditions are satisfied, or refraining from transmitting the update associated with the machine learning component to the server device based at least in part on a determination that the one or more reporting conditions are not satisfied.

Process 500 may include additional aspects, such as any single aspect or any combination of aspects described below and/or in connection with one or more other processes described elsewhere herein.

In a first aspect, the machine learning component comprises at least one neural network.

In a second aspect, alone or in combination with the first aspect, the one or more reporting conditions correspond to an amount of training data collected by the client device.

In a third aspect, alone or in combination with one or more of the first and second aspects, the one or more reporting conditions comprises a data quantity threshold, the method further comprising determining an amount of training data collected by the client device during a collection period, and determining that the amount of training data collected by the client device satisfies the data quantity threshold, wherein transmitting the update comprises transmitting the update based at least in part on determining that the amount of training data collected by the client device satisfies the data quantity threshold.

In a fourth aspect, alone or in combination with one or more of the first through third aspects, process 500 includes training the machine learning component based at least in part on determining that the amount of training data collected by the client device satisfies the data quantity threshold.

In a fifth aspect, alone or in combination with one or more of the first through fourth aspects, the one or more reporting condition correspond to a performance of the machine learning component.

In a sixth aspect, alone or in combination with one or more of the first through fifth aspects, the one or more reporting conditions correspond to a loss function value of the machine learning component.

In a seventh aspect, alone or in combination with one or more of the first through sixth aspects, the one or more reporting conditions correspond to a loss function difference, wherein the loss function difference comprises a difference between a first loss function value associated with the machine learning component and a second loss function value associated with the machine learning component.

In an eighth aspect, alone or in combination with one or more of the first through seventh aspects, the first loss function value corresponds to an initial instance of the machine learning component, and the second loss function value corresponds to an updated instance of the machine learning component.

In a ninth aspect, alone or in combination with one or more of the first through eighth aspects, process 500 includes receiving initial machine learning component information, and determining the initial instance of the machine learning component based at least in part on the initial machine learning component information.

In a tenth aspect, alone or in combination with one or more of the first through ninth aspects, process 500 includes determining the first loss function value, determining the second loss function value, determining the loss function difference, and determining that the loss function difference satisfies the reporting condition, wherein transmitting the update comprises transmitting the update based at least in part on determining that the loss function difference satisfies a loss function difference threshold.

In an eleventh aspect, alone or in combination with one or more of the first through tenth aspects, the one or more reporting conditions correspond to a use case associated with the machine learning component.

In a twelfth aspect, alone or in combination with one or more of the first through eleventh aspects, the use case comprises at least one of a channel state information derivation, a positioning measurement derivation, demodulation of a data channel, decoding of a data channel, or a combination thereof.

In a thirteenth aspect, alone or in combination with one or more of the first through twelfth aspects, the one or more reporting conditions correspond to a data type associated with a set of collected data.

In a fourteenth aspect, alone or in combination with one or more of the first through thirteenth aspects, the data type comprises identical independent distributed data, wherein transmitting the update is based at least in part on a determination that the set of collected data comprises identical independent distributed data.

In a fifteenth aspect, alone or in combination with one or more of the first through fourteenth aspects, the reporting configuration indicates at least one communication resource to be used for reporting the update.

In a sixteenth aspect, alone or in combination with one or more of the first through fifteenth aspects, the at least one communication resource comprises at least one of a time resource or a frequency resource.

In a seventeenth aspect, alone or in combination with one or more of the first through sixteenth aspects, process 500 includes transmitting, to the server device, an indication that the client device is refraining from transmitting the update.

In an eighteenth aspect, alone or in combination with one or more of the first through seventeenth aspects, transmitting the update to the server device comprises transmitting a report of a first type, and transmitting, to the server device, the indication that the client device is refraining from transmitting the update comprises transmitting a report of a second type.

In a nineteenth aspect, alone or in combination with one or more of the first through eighteenth aspects, the report of the second type indicates a reporting delay.

In a twentieth aspect, alone or in combination with one or more of the first through nineteenth aspects, the reporting delay comprises at least one time resource or frequency resource during which the client device will refrain from reporting an additional update.

In a twenty-first aspect, alone or in combination with one or more of the first through twentieth aspects, the report of the second type indicates a current instance of the machine learning component.

In a twenty-second aspect, alone or in combination with one or more of the first through twenty-first aspects, the report of the second type indicates at least one of a loss function value associated with a set of training data or a loss function value associated with a set of validation data.

In a twenty-third aspect, alone or in combination with one or more of the first through twenty-second aspects, the client device comprises a user equipment and the server device comprises a base station.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a server device, in accordance with the present disclosure. Example process 600 is an example where the server device (e.g., server device 308 shown in FIG. 3, server device 410 shown in FIG. 4) performs operations associated with machine learning component update reporting in federated learning.

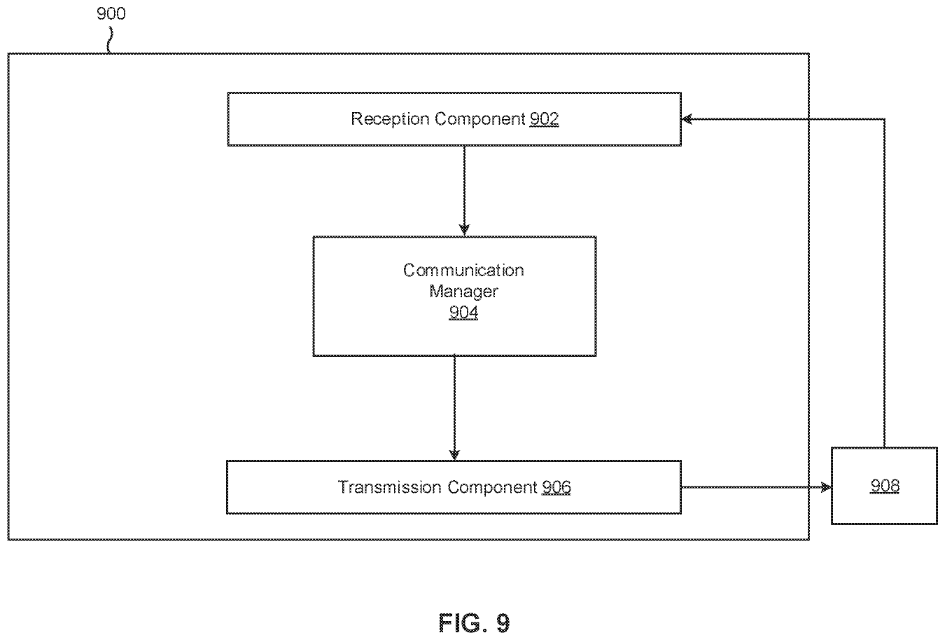

As shown in FIG. 6, in some aspects, process 600 may include transmitting, to a client device, a reporting configuration that indicates one or more reporting conditions, wherein the reporting configuration further indicates that, based at least in part on the one or more reporting conditions being satisfied, the client device is to report an update associated with a machine learning component (block 610). For example, the server device (e.g., using transmission component 906, depicted in FIG. 9) may transmit, to a client device, a reporting configuration that indicates one or more reporting conditions, wherein the reporting configuration further indicates that, based at least in part on the one or more reporting conditions being satisfied, the client device is to report an update associated with a machine learning component, as described above.

As further shown in FIG. 6, in some aspects, process 600 may include receiving the update associated with the machine learning component from the client device based at least in part on whether the one or more reporting conditions are satisfied (block 620). For example, the server device (e.g., using reception component 902, depicted in FIG. 9) may receive the update associated with the machine learning component from the client device based at least in part on whether the one or more reporting conditions are satisfied. For example, the server device may receive the update based at least in part on a determination that the one or more reporting conditions are satisfied, or failing to receive the update associated with the machine learning component to the server device based at least in part on a determination that the one or more reporting conditions are not satisfied.

Process 600 may include additional aspects, such as any single aspect or any combination of aspects described below and/or in connection with one or more other processes described elsewhere herein.

In a first aspect, the machine learning component comprises at least one neural network.

In a second aspect, alone or in combination with the first aspect, the one or more reporting conditions correspond to an amount of training data collected by the client device.

In a third aspect, alone or in combination with one or more of the first and second aspects, the one or more reporting conditions comprises a data quantity threshold, wherein receiving the update comprises receiving the update based at least in part on a determination that the amount of training data collected by the client device satisfies the data quantity threshold.

In a fourth aspect, alone or in combination with one or more of the first through third aspects, the reporting configuration comprises an indication to train the machine learning component based at least in part on a determination that the amount of training data collected by the client device satisfies the data quantity threshold.

In a fifth aspect, alone or in combination with one or more of the first through fourth aspects, the one or more reporting condition correspond to a performance of the machine learning component.

In a sixth aspect, alone or in combination with one or more of the first through fifth aspects, the one or more reporting conditions correspond to a loss function value of the machine learning component.

In a seventh aspect, alone or in combination with one or more of the first through sixth aspects, the one or more reporting conditions correspond to a loss function difference, wherein the loss function difference comprises a difference between a first loss function value associated with the machine learning component and a second loss function value associated with the machine learning component.

In an eighth aspect, alone or in combination with one or more of the first through seventh aspects, the first loss function value corresponds to an initial instance of the machine learning component, and the second loss function value corresponds to an updated instance of the machine learning component.

In a ninth aspect, alone or in combination with one or more of the first through eighth aspects, receiving the update comprises receiving the update based at least in part on a determination that the loss function difference satisfies a loss function difference threshold.

In a tenth aspect, alone or in combination with one or more of the first through ninth aspects, the one or more reporting conditions correspond to a use case associated with the machine learning component.

In an eleventh aspect, alone or in combination with one or more of the first through tenth aspects, the use case comprises at least one of a channel state information derivation, a positioning measurement derivation, demodulation of a data channel, decoding of a data channel, or a combination thereof.

In a twelfth aspect, alone or in combination with one or more of the first through eleventh aspects, the one or more reporting conditions corresponds to a data type associated with a set of collected data.

In a thirteenth aspect, alone or in combination with one or more of the first through twelfth aspects, the data type comprises identical independent distributed data, wherein receiving the update is based at least in part on a determination that the set of collected data comprises identical independent distributed data.

In a fourteenth aspect, alone or in combination with one or more of the first through thirteenth aspects, the reporting configuration indicates at least one communication resource to be used for reporting the update.

In a fifteenth aspect, alone or in combination with one or more of the first through fourteenth aspects, the at least one communication resource comprises at least one of a time resource or a frequency resource.

In a sixteenth aspect, alone or in combination with one or more of the first through fifteenth aspects, process 600 includes determining that the update has not been received from the client device.

In a seventeenth aspect, alone or in combination with one or more of the first through sixteenth aspects, determining that the update has not been received from the client device comprises performing a blind detection procedure.

In an eighteenth aspect, alone or in combination with one or more of the first through seventeenth aspects, determining that the update has not been received from the client device comprises receiving, from the client device, an indication that the client device is refraining from transmitting the update.

In a nineteenth aspect, alone or in combination with one or more of the first through eighteenth aspects, receiving the update from the client device comprises receiving a report of a first type, and receiving, from the client device, the indication that the client device is refraining from transmitting the update comprises receiving a report of a second type.

In a twentieth aspect, alone or in combination with one or more of the first through nineteenth aspects, the report of the second type indicates a reporting delay.

In a twenty-first aspect, alone or in combination with one or more of the first through twentieth aspects, the reporting delay comprises at least one time resource or frequency resource during which the client device will refrain from reporting an additional update.

In a twenty-second aspect, alone or in combination with one or more of the first through twenty-first aspects, the report of the second type indicates a current instance of the machine learning component.

In a twenty-third aspect, alone or in combination with one or more of the first through twenty-second aspects, the report of the second type indicates at least one of a loss function value associated with a set of training data or a loss function value associated with a set of validation data.

In a twenty-fourth aspect, alone or in combination with one or more of the first through twenty-third aspects, the client device comprises a user equipment and the server device comprises a base station.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication in accordance with the present disclosure. The apparatus 700 may be, be similar to, include, or be included in a client device (e.g., client device 302 shown in FIG. 3 and/or client 405 device shown in FIG. 4). In some aspects, the apparatus 700 includes a reception component 702, a communication manager 704, and a transmission component 706, which may be in communication with one another (for example, via one or more buses). As shown, the apparatus 700 may communicate with another apparatus 708 (such as a client device, a server, a UE, a base station, or another wireless communication device) using the reception component 702 and the transmission component 706.

In some aspects, the apparatus 700 may be configured to perform one or more operations described herein in connection with FIGS. 3 and/or 4. Additionally, or alternatively, the apparatus 700 may be configured to perform one or more processes described herein, such as process 500 of FIG. 5. In some aspects, the apparatus 700 may include one or more components of the first UE described above in connection with FIG. 2.

The reception component 702 may provide means for receiving communications, such as reference signals, control information, data communications, or a combination thereof, from the apparatus 708. The reception component 702 may provide received communications to one or more other components of the apparatus 700, such as the communication manager 704. In some aspects, the reception component 702 may provide means for signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, a demodulator, a MIMO detector, a receive processor, a controller/processor, a memory, or a combination thereof, of the first UE described above in connection with FIG. 2.

The transmission component 706 may provide means for transmitting communications, such as reference signals, control information, data communications, or a combination thereof, to the apparatus 708. In some aspects, the communication manager 704 may generate communications and may transmit the generated communications to the transmission component 706 for transmission to the apparatus 708. In some aspects, the transmission component 706 may provide means for performing signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 706 may include one or more antennas, a modulator, a transmit MIMO processor, a transmit processor, a controller/processor, a memory, or a combination thereof, of the first UE described above in connection with FIG. 2. In some aspects, the transmission component 706 may be co-located with the reception component 702 in a transceiver.

In some aspects, the communication manager 704 may provide means for receiving a reporting configuration that indicates one or more reporting conditions, wherein the reporting configuration further indicates that, based at least in part on the one or more reporting conditions being satisfied, the client device is to report an update associated with a machine learning component; and transmitting the update associated with the machine learning component to the server device based at least in part on whether the one or more reporting conditions are satisfied. In some aspects, the communication manager 704 may include a controller/processor, a memory, or a combination thereof, of the first UE described above in connection with FIG. 2. In some aspects, the communication manager 704 may include the reception component 702, the transmission component 706, and/or the like. In some aspects, the means provided by the communication manager 704 may include, or be included within, means provided by the reception component 702, the transmission component 706, and/or the like.

In some aspects, the communication manager 704 and/or one or more components of the communication manager 704 may include or may be implemented within hardware (e.g., one or more of the circuitry described in connection with FIG. 20). In some aspects, the communication manager 704 and/or one or more components thereof may include or may be implemented within a controller/processor, a memory, or a combination thereof, of the UE 120 described above in connection with FIG. 2.

In some aspects, the communication manager 704 and/or one or more components of the communication manager 704 may be implemented in code (e.g., as software or firmware stored in a memory). For example, the communication manager 704 and/or a component (or a portion of a component) of the communication manager 704 may be implemented as instructions or code stored in a non-transitory computer-readable medium and executable by a controller or a processor to perform the functions or operations of the communication manager 704 and/or the component. If implemented in code, the functions of the communication manager 704 and/or a component may be executed by a controller/processor, a memory, a scheduler, a communication unit, or a combination thereof, of the UE 120 described above in connection with FIG. 2.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

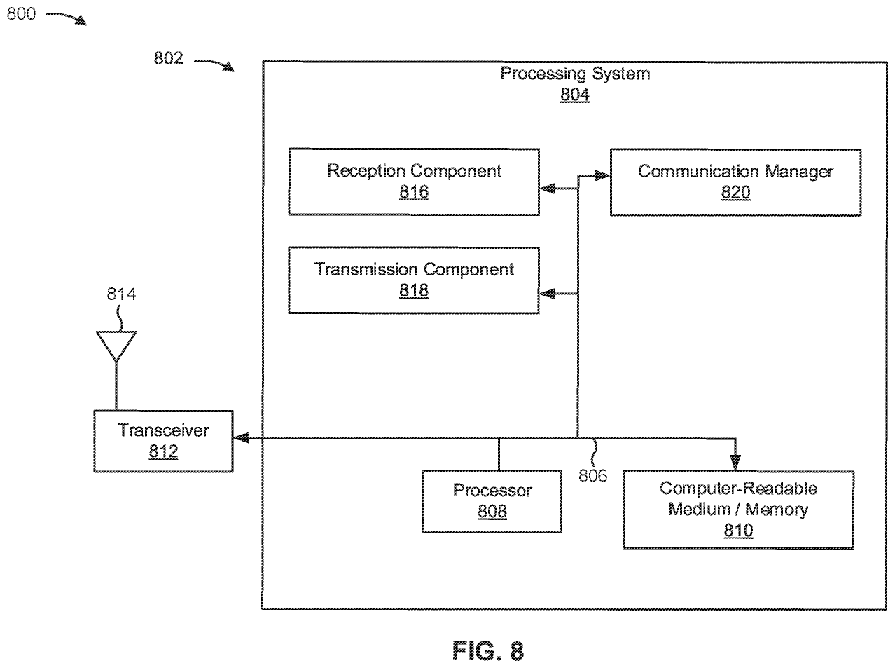

FIG. 8 is a diagram illustrating an example 800 of a hardware implementation for an apparatus 802 employing a processing system 804. The apparatus 802 may be, be similar to, include, or be included in the apparatus 700 shown in FIG. 7.

The processing system 804 may be implemented with a bus architecture, represented generally by the bus 806. The bus 806 may include any number of interconnecting buses and bridges depending on the specific application of the processing system 804 and the overall design constraints. The bus 806 links together various circuits including one or more processors and/or hardware components, represented by a processor 808, the illustrated components, and the computer-readable medium/memory 810. The bus 806 may also link various other circuits, such as timing sources, peripherals, voltage regulators, power management circuits, and/or the like.

The processing system 804 may be coupled to a transceiver 812. The transceiver 812 is coupled to one or more antennas 814. The transceiver 812 provides a means for communicating with various other apparatuses over a transmission medium. The transceiver 812 receives a signal from the one or more antennas 814, extracts information from the received signal, and provides the extracted information to the processing system 804, specifically a reception component 816. In addition, the transceiver 812 receives information from the processing system 804, specifically a transmission component 818, and generates a signal to be applied to the one or more antennas 814 based at least in part on the received information.

The processor 808 is coupled to the computer-readable medium/memory 810. The processor 808 is responsible for general processing, including the execution of software stored on the computer-readable medium/memory 810. The software, when executed by the processor 808, causes the processing system 804 to perform the various functions described herein in connection with a client. The computer-readable medium/memory 810 may also be used for storing data that is manipulated by the processor 808 when executing software. The processing system 804 may include a communication manager 820 and/or any number of additional components not illustrated in FIG. 8. The components illustrated and/or not illustrated may be software modules running in the processor 808, resident/stored in the computer readable medium/memory 810, one or more hardware modules coupled to the processor 808, or some combination thereof.

In some aspects, the processing system 804 may be a component of the UE 120 and may include the memory 282 and/or at least one of the TX MIMO processor 266, the RX processor 258, and/or the controller/processor 280. In some aspects, the apparatus 802 for wireless communication provides means for receiving a reporting configuration that indicates one or more reporting conditions, wherein the reporting configuration further indicates that, based at least in part on the one or more reporting conditions being satisfied, the client device is to report an update associated with a machine learning component; and transmitting the update associated with the machine learning component to the server device based at least in part on whether the one or more reporting conditions are satisfied. The aforementioned means may be one or more of the aforementioned components of the processing system 804 of the apparatus 802 configured to perform the functions recited by the aforementioned means. As described elsewhere herein, the processing system 804 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 8 is provided as an example. Other examples may differ from what is described in connection with FIG. 8.

FIG. 9 is a block diagram of an example apparatus 900 for wireless communication in accordance with the present disclosure. The apparatus 900 may be, be similar to, include, or be included in a server device (e.g., server device 308 shown in FIG. 3 and/or server device 410 shown in FIG. 4). In some aspects, the apparatus 900 includes a reception component 902, a communication manager 904, and a transmission component 906, which may be in communication with one another (for example, via one or more buses). As shown, the apparatus 900 may communicate with another apparatus 908 (such as a client, a server, a UE, a base station, or another wireless communication device) using the reception component 902 and the transmission component 906.

In some aspects, the apparatus 900 may be configured to perform one or more operations described herein in connection with FIGS. 3 and/or 4. Additionally, or alternatively, the apparatus 900 may be configured to perform one or more processes described herein, such as process 600 of FIG. 6. In some aspects, the apparatus 900 may include one or more components of the base station described above in connection with FIG. 2.

The reception component 902 may provide means for receiving communications, such as reference signals, control information, data communications, or a combination thereof, from the apparatus 908. The reception component 902 may provide received communications to one or more other components of the apparatus 900, such as the communication manager 904. In some aspects, the reception component 902 may provide means for performing signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a demodulator, a MIMO detector, a receive processor, a controller/processor, a memory, or a combination thereof, of the base station described above in connection with FIG. 2.

The transmission component 906 may provide means for transmitting communications, such as reference signals, control information, data communications, or a combination thereof, to the apparatus 908. In some aspects, the communication manager 904 may generate communications and may transmit the generated communications to the transmission component 906 for transmission to the apparatus 908. In some aspects, the transmission component 906 may provide means for performing signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 906 may include one or more antennas, a modulator, a transmit MIMO processor, a transmit processor, a controller/processor, a memory, or a combination thereof, of the base station described above in connection with FIG. 2. In some aspects, the transmission component 906 may be co-located with the reception component 902 in a transceiver.

The communication manager 904 may provide means for transmitting, to a client device, a reporting configuration that indicates one or more reporting conditions, wherein the reporting configuration further indicates that, based at least in part on the one or more reporting conditions being satisfied, the client device is to report an update associated with a machine learning component; and receiving the update associated with the machine learning component from the client device based at least in part on a determination that the one or more reporting conditions are satisfied, or failing to receive the update associated with the machine learning component to the server device based at least in part on a determination that the one or more reporting conditions are not satisfied. In some aspects, the communication manager 904 may include a controller/processor, a memory, a scheduler, a communication unit, or a combination thereof, of the base station described above in connection with FIG. 2. In some aspects, the communication manager 904 may include the reception component 902, the transmission component 906, and/or the like. In some aspects, the means provided by the communication manager 904 may include, or be included within, means provided by the reception component 902, the transmission component 906, and/or the like.

In some aspects, the communication manager 904 and/or one or more components thereof may include or may be implemented within hardware (e.g., one or more of the circuitry described in connection with FIG. 13). In some aspects, the communication manager 904 and/or one or more components thereof may include or may be implemented within a controller/processor, a memory, or a combination thereof, of the BS 90 described above in connection with FIG. 2.

In some aspects, the communication manager 904 and/or one or more components thereof may be implemented in code (e.g., as software or firmware stored in a memory). For example, the communication manager 904 and/or a component (or a portion of a component) of the communication manager 904 may be implemented as instructions or code stored in a non-transitory computer-readable medium and executable by a controller or a processor to perform the functions or operations of the communication manager 904 and/or the component. If implemented in code, the functions of the communication manager 904 and/or a component may be executed by a controller/processor, a memory, a scheduler, a communication unit, or a combination thereof, of the BS 110 described above in connection with FIG. 2.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

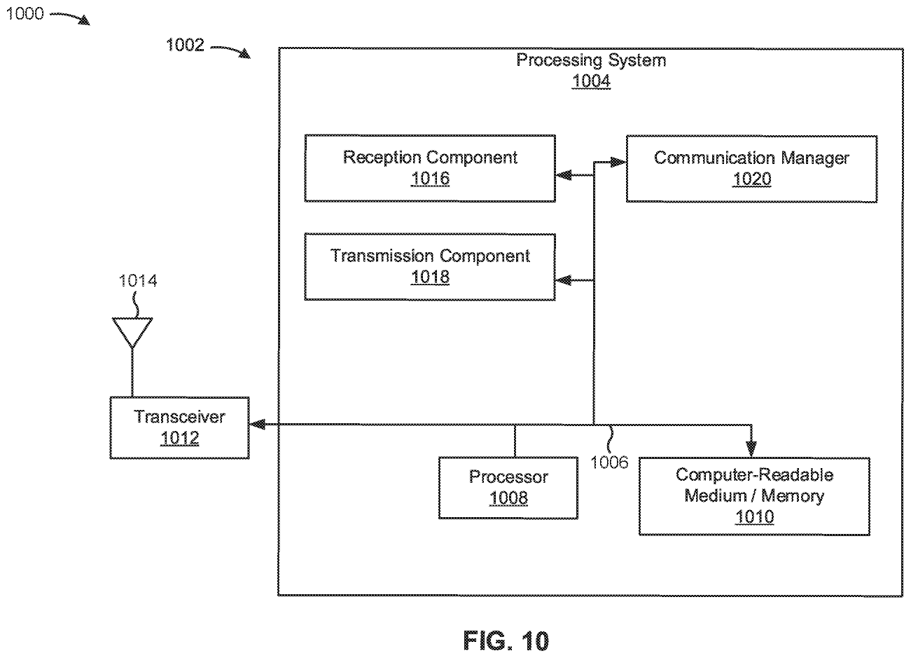

FIG. 10 is a diagram illustrating an example 1000 of a hardware implementation for an apparatus 1002 employing a processing system 1004. The apparatus 1002 may be, be similar to, include, or be included in the apparatus 900 shown in FIG. 9.

The processing system 1004 may be implemented with a bus architecture, represented generally by the bus 1006. The bus 1006 may include any number of interconnecting buses and bridges depending on the specific application of the processing system 1004 and the overall design constraints. The bus 1006 links together various circuits including one or more processors and/or hardware components, represented by a processor 1008, the illustrated components, and the computer-readable medium/memory 1010. The bus 1006 may also link various other circuits, such as timing sources, peripherals, voltage regulators, power management circuits, and/or the like.

The processing system 1004 may be coupled to a transceiver 1012. The transceiver 1012 is coupled to one or more antennas 1014. The transceiver 1012 provides a means for communicating with various other apparatuses over a transmission medium. The transceiver 1012 receives a signal from the one or more antennas 1014, extracts information from the received signal, and provides the extracted information to the processing system 1004, specifically a reception component 1016. In addition, the transceiver 1012 receives information from the processing system 1004, specifically a transmission component 1018, and generates a signal to be applied to the one or more antennas 1014 based at least in part on the received information.

The processor 1008 is coupled to the computer-readable medium/memory 1010. The processor 1008 is responsible for general processing, including the execution of software stored on the computer-readable medium/memory 1010. The software, when executed by the processor 1008, causes the processing system 1004 to perform the various functions described herein in connection with a server. The computer-readable medium/memory 1010 may also be used for storing data that is manipulated by the processor 1008 when executing software. The processing system 1004 may include a communication manager 1020 and/or any number of additional components not illustrated in FIG. 10. The components illustrated and/or not illustrated may be software modules running in the processor 1008, resident/stored in the computer readable medium/memory 1010, one or more hardware modules coupled to the processor 1008, or some combination thereof.

In some aspects, the processing system 1004 may be a component of the UE 120 and may include the memory 282 and/or at least one of the TX MIMO processor 266, the RX processor 258, and/or the controller/processor 280. In some aspects, the apparatus 1002 for wireless communication provides means for transmitting, to a client device, a reporting configuration that indicates one or more reporting conditions, wherein the reporting configuration further indicates that, based at least in part on the one or more reporting conditions being satisfied, the client device is to report an update associated with a machine learning component; and receiving the update associated with the machine learning component from the client device based at least in part on a determination that the one or more reporting conditions are satisfied, or failing to receive the update associated with the machine learning component to the server device based at least in part on a determination that the one or more reporting conditions are not satisfied. The aforementioned means may be one or more of the aforementioned components of the processing system 1004 of the apparatus 1002 configured to perform the functions recited by the aforementioned means. As described elsewhere herein, the processing system 1004 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 10 is provided as an example. Other examples may differ from what is described in connection with FIG. 10.

The following provides an overview of some Aspects of the present disclosure:

Aspect 1: A method of wireless communication performed by a client device, comprising: receiving a reporting configuration that indicates one or more reporting conditions, wherein the reporting configuration further indicates that, based at least in part on the one or more reporting conditions being satisfied, the client device is to report an update associated with a machine learning component; and transmitting the update associated with the machine learning component to the server device based at least in part on a determination that the one or more reporting conditions are satisfied, or refraining from transmitting the update associated with the machine learning component to the server device based at least in part on whether the one or more reporting conditions are not satisfied.

Aspect 2: The method of Aspect 1, wherein the machine learning component comprises at least one neural network.

Aspect 3: The method of either of Aspects 1 or 2, wherein the one or more reporting conditions correspond to an amount of training data collected by the client device.

Aspect 4: The method of any of Aspects 1-3, wherein the one or more reporting conditions comprises a data quantity threshold, the method further comprising: determining an amount of training data collected by the client device during a collection period; and determining that the amount of training data collected by the client device satisfies the data quantity threshold, wherein transmitting the update comprises transmitting the update based at least in part on determining that the amount of training data collected by the client device satisfies the data quantity threshold.

Aspect 5: The method of Aspect 4, further comprising: training the machine learning component based at least in part on determining that the amount of training data collected by the client device satisfies the data quantity threshold.

Aspect 6: The method of any of Aspects 1-5, wherein the one or more reporting condition correspond to a performance of the machine learning component.

Aspect 7: The method of any of Aspects 1-6, wherein the one or more reporting conditions correspond to a loss function value of the machine learning component.

Aspect 8: The method of any of Aspects 1-7, wherein the one or more reporting conditions correspond to a loss function difference, wherein the loss function difference comprises a difference between a first loss function value associated with the machine learning component and a second loss function value associated with the machine learning component.

Aspect 9: The method of Aspect 8, wherein the first loss function value corresponds to an initial instance of the machine learning component, and wherein the second loss function value corresponds to an updated instance of the machine learning component.

Aspect 10: The method of Aspect 9, further comprising: receiving initial machine learning component information; and determining the initial instance of the machine learning component based at least in part on the initial machine learning component information.

Aspect 11: The method of either of Aspects 9 or 10, further comprising: determining the first loss function value; determining the second loss function value; determining the loss function difference; and determining that the loss function difference satisfies the reporting condition, wherein transmitting the update comprises transmitting the update based at least in part on determining that the loss function difference satisfies a loss function difference threshold.

Aspect 12: The method of any of Aspects 1-11, wherein the one or more reporting conditions correspond to a use case associated with the machine learning component.

Aspect 13: The method of Aspect 12, wherein the use case comprises at least one of: a channel state information derivation, a positioning measurement derivation, demodulation of a data channel, decoding of a data channel, or a combination thereof.

Aspect 14: The method of any of Aspects 1-13, wherein the one or more reporting conditions correspond to a data type associated with a set of collected data.

Aspect 15: The method of Aspect 14, wherein the data type comprises identical independent distributed data, wherein transmitting the update is based at least in part on a determination that the set of collected data comprises identical independent distributed data.

Aspect 16: The method of any of Aspects 1-15, wherein the reporting configuration indicates at least one communication resource to be used for reporting the update.

Aspect 17: The method of Aspect 16, wherein the at least one communication resource comprises at least one of a time resource or a frequency resource.

Aspect 18: The method of any of Aspects 1-17, further comprising transmitting, to the server device, an indication that the client device is refraining from transmitting the update.

Aspect 19: The method of Aspect 18, wherein transmitting the update to the server device comprises transmitting a report of a first type, and wherein transmitting, to the server device, the indication that the client device is refraining from transmitting the update comprises transmitting a report of a second type.

Aspect 20: The method of Aspect 19, wherein the report of the second type indicates a reporting delay.

Aspect 21: The method of Aspect 20, wherein the reporting delay comprises at least one time resource or frequency resource during which the client device will refrain from reporting an additional update.

Aspect 22: The method of any of Aspects 19-21, wherein the report of the second type indicates a current instance of the machine learning component.

Aspect 23: The method of any of Aspects 19-22, wherein the report of the second type indicates at least one of a loss function value associated with a set of training data or a loss function value associated with a set of validation data.

Aspect 24: The method of any of Aspects 1-23, wherein the client device comprises a user equipment and wherein the server device comprises a base station.

Aspect 25: A method of wireless communication performed by a server device, comprising: transmitting, to a client device, a reporting configuration that indicates one or more reporting conditions, wherein the reporting configuration further indicates that, based at least in part on the one or more reporting conditions being satisfied, the client device is to report an update associated with a machine learning component; and receiving the update associated with the machine learning component from the client device based at least in part on whether the one or more reporting conditions are satisfied, or failing to receive the update associated with the machine learning component to the server device based at least in part on a determination that the one or more reporting conditions are not satisfied.

Aspect 26: The method of Aspect 25, wherein the machine learning component comprises at least one neural network.

Aspect 27: The method of either of Aspects 25 or 26, wherein the one or more reporting conditions correspond to an amount of training data collected by the client device.

Aspect 28: The method of Aspect 27, wherein the one or more reporting conditions comprises a data quantity threshold, wherein receiving the update comprises receiving the update based at least in part on a determination that the amount of training data collected by the client device satisfies the data quantity threshold.

Aspect 29: The method of Aspect 28, wherein the reporting configuration comprises an indication to train the machine learning component based at least in part on a determination that the amount of training data collected by the client device satisfies the data quantity threshold.

Aspect 30: The method of any of Aspects 25-29, wherein the one or more reporting condition correspond to a performance of the machine learning component.

Aspect 31: The method of any of Aspects 25-30, wherein the one or more reporting conditions correspond to a loss function value of the machine learning component.

Aspect 32: The method of any of Aspects 25-31, wherein the one or more reporting conditions correspond to a loss function difference, wherein the loss function difference comprises a difference between a first loss function value associated with the machine learning component and a second loss function value associated with the machine learning component.

Aspect 33: The method of Aspect 32, wherein the first loss function value corresponds to an initial instance of the machine learning component, and wherein the second loss function value corresponds to an updated instance of the machine learning component.

Aspect 34: The method of either of Aspects 32 or 34, wherein receiving the update comprises receiving the update based at least in part on a determination that the loss function difference satisfies a loss function difference threshold.

Aspect 35: The method of any of Aspects 25-34, wherein the one or more reporting conditions correspond to a use case associated with the machine learning component.

Aspect 36: The method of Aspect 35, wherein the use case comprises at least one of: a channel state information derivation, a positioning measurement derivation, demodulation of a data channel, decoding of a data channel, or a combination thereof.

Aspect 37: The method of any of Aspects 25-36, wherein the one or more reporting conditions corresponds to a data type associated with a set of collected data.

Aspect 38: The method of Aspect 37, wherein the data type comprises identical independent distributed data, wherein receiving the update is based at least in part on a determination that the set of collected data comprises identical independent distributed data.

Aspect 39: The method of any of Aspects 25-38, wherein the reporting configuration indicates at least one communication resource to be used for reporting the update.

Aspect 40: The method of Aspect 39, wherein the at least one communication resource comprises at least one of a time resource or a frequency resource.

Aspect 41: The method of any of Aspects 25-40, further comprising determining that the update has not been received from the client device.

Aspect 42: The method of Aspect 41, wherein determining that the update has not been received from the client device comprises performing a blind detection procedure.

Aspect 43: The method of either of Aspects 41 or 42, wherein determining that the update has not been received from the client device comprises receiving, from the client device, an indication that the client device is refraining from transmitting the update.

Aspect 44: The method of Aspect 43, wherein receiving the update from the client device comprises receiving a report of a first type, and wherein receiving, from the client device, the indication that the client device is refraining from transmitting the update comprises receiving a report of a second type.

Aspect 45: The method of Aspect 44, wherein the report of the second type indicates a reporting delay.

Aspect 46: The method of Aspect 45, wherein the reporting delay comprises at least one time resource or frequency resource during which the client device will refrain from reporting an additional update.

Aspect 47: The method of any of Aspects 44-46, wherein the report of the second type indicates a current instance of the machine learning component.

Aspect 48: The method of any of Aspects 44-47, wherein the report of the second type indicates at least one of a loss function value associated with a set of training data or a loss function value associated with a set of validation data.

Aspect 49: The method of any of Aspects 25-48, wherein the client device comprises a user equipment and wherein the server device comprises a base station.

Aspect 50: An apparatus for wireless communication at a device, comprising a processor; memory coupled with the processor; and instructions stored in the memory and executable by the processor to cause the apparatus to perform the method of one or more of Aspects 1-24.

Aspect 51: A device for wireless communication, comprising a memory and one or more processors coupled to the memory, the one or more processors configured to perform the method of one or more of Aspects 1-24.

Aspect 52: An apparatus for wireless communication, comprising at least one means for performing the method of one or more of Aspects 1-24.

Aspect 53: A non-transitory computer-readable medium storing code for wireless communication, the code comprising instructions executable by a processor to perform the method of one or more of Aspects 1-24.

Aspect 54: A non-transitory computer-readable medium storing a set of instructions for wireless communication, the set of instructions comprising one or more instructions that, when executed by one or more processors of a device, cause the device to perform the method of one or more of Aspects 1-24.

Aspect 55: An apparatus for wireless communication at a device, comprising a processor; memory coupled with the processor; and instructions stored in the memory and executable by the processor to cause the apparatus to perform the method of one or more of Aspects 25-49.

Aspect 56: A device for wireless communication, comprising a memory and one or more processors coupled to the memory, the one or more processors configured to perform the method of one or more of Aspects 25-49.

Aspect 57: An apparatus for wireless communication, comprising at least one means for performing the method of one or more of Aspects 25-49.

Aspect 58: A non-transitory computer-readable medium storing code for wireless communication, the code comprising instructions executable by a processor to perform the method of one or more of Aspects 25-49.

Aspect 59: A non-transitory computer-readable medium storing a set of instructions for wireless communication, the set of instructions comprising one or more instructions that, when executed by one or more processors of a device, cause the device to perform the method of one or more of Aspects 25-49.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A client device for wireless communication, comprising:
a memory; and
one or more processors, coupled to the memory, configured to:
receive, from a server device, a reporting configuration that indicates one or more reporting conditions, wherein the reporting configuration further indicates that, based at least in part on the one or more reporting conditions being satisfied, the client device is to report an update associated with a machine learning component; and
transmit the update associated with the machine learning component to the server device based at least in part whether the one or more reporting conditions are satisfied.

2. The client device of claim 1, wherein the one or more reporting conditions correspond to an amount of training data collected by the client device.

3. The client device of claim 1, wherein the one or more reporting conditions comprises a data quantity threshold, and wherein the one or more processors are further configured to:
determine an amount of training data collected by the client device during a collection period; and
determine that the amount of training data collected by the client device satisfies the data quantity threshold,
wherein the one or more processors, to transmit the update, are configured to transmit the update based at least in part on determining that the amount of training data collected by the client device satisfies the data quantity threshold.

4. The client device of claim 3, wherein the one or more processors are further configured to:
train the machine learning component based at least in part on determining that the amount of training data collected by the client device satisfies the data quantity threshold.

5. The client device of claim 1, wherein the one or more reporting condition correspond to a performance of the machine learning component.

6. The client device of claim 1, wherein the one or more reporting conditions correspond to a loss function value of the machine learning component.

7. The client device of claim 1, wherein the one or more reporting conditions correspond to a loss function difference, wherein the loss function difference comprises a difference between a first loss function value associated with the machine learning component and a second loss function value associated with the machine learning component.

8. The client device of claim 7, wherein the first loss function value corresponds to an initial instance of the machine learning component, and wherein the second loss function value corresponds to an updated instance of the machine learning component.

9. The client device of claim 8, wherein the one or more processors are further configured to:
receive initial machine learning component information; and
determine the initial instance of the machine learning component based at least in part on the initial machine learning component information.

10. The client device of claim 9, wherein the one or more processors are further configured to:
determine the first loss function value;
determine the second loss function value;
determine the loss function difference; and
determine that the loss function difference satisfies the reporting condition,
wherein the one or more processors, to transmit the update, are configured to transmit the update based at least in part on determining that the loss function difference satisfies a loss function difference threshold.

11. The client device of claim 1, wherein the one or more reporting conditions correspond to a use case associated with the machine learning component.

12. The client device of claim 11, wherein the use case comprises at least one of:
a channel state information derivation,
a positioning measurement derivation,
demodulation of a data channel,
decoding of a data channel, or
a combination thereof.

13. The client device of claim 1, wherein the one or more reporting conditions correspond to a data type associated with a set of collected data.

14. The client device of claim 13, wherein the data type comprises identical independent distributed data, wherein transmitting the update is based at least in part on a determination that the set of collected data comprises identical independent distributed data.

15. The client device of claim 1, wherein the reporting configuration indicates at least one communication resource to be used for reporting the update.

16. The client device of claim 15, wherein the at least one communication resource comprises at least one of a time resource or a frequency resource.

17. The client device of claim 1, wherein the one or more processors are further configured to transmit, to the server device, an indication that the client device is refraining from transmitting the update.

18. The client device of claim 17, wherein the one or more processors, to transmit the update to the server device, are configured to transmit a report of a first type, and wherein the one or more processors, to transmit, to the server device, the indication that the client device is refraining from transmitting the update, are configured to transmit a report of a second type.

19. The client device of claim 18, wherein the report of the second type indicates a reporting delay.

20. The client device of claim 19, wherein the reporting delay comprises at least one time resource or frequency resource during which the client device will refrain from reporting an additional update.

21. The client device of claim 18, wherein the report of the second type indicates a current instance of the machine learning component.

22. The client device of claim 18, wherein the report of the second type indicates at least one of a loss function value associated with a set of training data or a loss function value associated with a set of validation data.

23. The client device of claim 1, wherein the client device comprises a user equipment and wherein the server device comprises a base station.

24. A server device for wireless communication, comprising:
a memory; and
one or more processors, coupled to the memory, configured to:
transmit, to a client device, a reporting configuration that indicates one or more reporting conditions, wherein the reporting configuration further indicates that, based at least in part on the one or more reporting conditions being satisfied, the client device is to report an update associated with a machine learning component; and
receive the update associated with the machine learning component from the client device based at least in part on whether the one or more reporting conditions are satisfied.

25. The server device of claim 24, wherein the one or more reporting conditions correspond to at least one of:
an amount of training data collected by the client device,
a performance of the machine learning component,
a loss function value of the machine learning component,
a use case associated with the machine learning component, or
a data type associated with a set of collected data.

26. The server device of claim 24, wherein the reporting configuration indicates at least one communication resource to be used for reporting the update.

27. A method of wireless communication performed by a client device, comprising:
receiving, from a server device, a reporting configuration that indicates one or more reporting conditions, wherein the reporting configuration further indicates that, based at least in part on the one or more reporting conditions being satisfied, the client device is to report an update associated with a machine learning component; and
transmitting the update associated with the machine learning component to the server device based at least in part on whether the one or more reporting conditions are satisfied.

28. The method of claim 27, wherein the one or more reporting conditions comprise a data quantity threshold, the method further comprising:
determining an amount of training data collected by the client device during a collection period; and
determining that the amount of training data collected by the client device satisfies the data quantity threshold,
wherein transmitting the update comprises transmitting the update based at least in part on determining that the amount of training data collected by the client device satisfies the data quantity threshold.

29. The method of claim 27, wherein the one or more reporting conditions correspond to a loss function difference, wherein the loss function difference comprises a difference between a first loss function value associated with the machine learning component and a second loss function value associated with the machine learning component.

30. A method of wireless communication performed by a server device, comprising:
transmitting, to a client device, a reporting configuration that indicates one or more reporting conditions, wherein the reporting configuration further indicates that, based at least in part on the one or more reporting conditions being satisfied, the client device is to report an update associated with a machine learning component; and
receiving the update associated with the machine learning component from the client device based at least in part on whether the one or more reporting conditions are satisfied.
